(19) United States
(12) Patent Application Publication
(10) Pub. No.: US 2012/0200061 A1
(43) Pub. Date: Aug. 9, 2012

(54) DUAL SHIFTER FOR A BICYCLE

(75) Inventor: Christopher P. D'Aluisio, Corralitos, CA (US)

(73) Assignee: SPECIALIZED BICYCLE COMPONENTS, INC., Morgan Hill, CA (US)

(21) Appl. No.: 13/022,962

(22) Filed: Feb. 8, 2011

(51) Int. Cl. B62K 23/06; B62M 25/04; F16C 1/12; B62K 3/02

(52) U.S. Cl. 280/281.1

(57) ABSTRACT

A bicycle having at least two wheels, a frame supported on the two wheels, a brake, a gear shift mechanism (e.g., a chain derailleur), a shifter (e.g., a shift lever), and a brake mechanism coupled to the brake and also coupled to the gear mechanism (e.g., via an auxiliary shift cable between a brake lever and a shift lever). Preferably, the shifter and brake mechanism are mounted on a handlebar assembly (e.g., the shifter mounted on an extension and the brake mechanism mounted on a base bar). In one embodiment, the brake mechanism comprises a brake support fixedly secured to the handlebar assembly, a lever base pivotally mounted to the brake support for rotation about a first axis, and a brake lever pivotally mounted to the lever base for rotation about a second axis. Preferably, the lever base is rotationally biased relative to the brake support.

### BACKGROUND

The present invention relates generally to bicycles, and more specifically to mechanisms for shifting gears on bicycles.

Bicycles are commonly driven by a chain that connects a front sprocket connected to the pedal to a rear sprocket connected to the rear wheel. Many bicycles have multiple sprockets on the front or rear in order to provide the ability to select different gear ratios between the front and rear sprockets. On such bicycles, changing gears involves moving the chain from one sprocket to another sprocket using a derailleur. The derailleur is commonly controlled by a shift lever mounted on the handlebars and connected to the derailleur by a shift cable.

Some bicycles have handlebars that provide multiple locations for a user to grab. For example, one type of bicycle is a time trial bicycle that commonly includes at least two different locations for placing a user's hands. In a first location, the hands are widely spaced, and in a second location, the hands are narrowly spaced and positioned further forward. The first position is commonly used when the rider desires better steering control or wants to stand up to provide more power to the pedals, and the second position is commonly used when the rider desires a more aerodynamic riding position.

### SUMMARY OF THE INVENTION

The present invention provides a bicycle that facilitates actuation of the gear shift mechanism from multiple locations. Specifically, the bicycle includes at least two wheels, a frame supported on the two wheels, a brake, a gear shift mechanism (e.g., a chain derailleur), a shifter (e.g., a shift lever) for changing a gear ratio of the gear shift mechanism, and a brake mechanism coupled to the brake and also coupled to the gear mechanism (e.g., via an auxiliary shift cable between a brake lever and a shift lever). Preferably, the shifter and brake mechanism are mounted on a handlebar assembly (e.g., the shifter mounted on an extension and the brake mechanism mounted on a base bar).

In one embodiment, the brake mechanism comprises a brake support fixedly secured to the handlebar assembly, a lever base pivotally mounted to the brake support for rotation about a first axis (e.g., a base axis), and a brake lever pivotally mounted to the lever base for rotation about a second axis (e.g., a lever axis). As a result of this arrangement, the brake lever is effectively movable in at least two different planes. Preferably, movement of the brake lever in one of the at least two different planes actuates the brake, and movement of the brake lever in the other of the at least two different planes actuates the gear mechanism.

Preferably, the lever base is rotationally biased relative to the brake support. The brake mechanism can further comprise an auxiliary shift cable secured to the lever base such that rotation of the lever base causes movement of the auxiliary shift cable. A brake cable is preferably positioned through both the brake support and the lever base and secured to the brake lever such that movement of the brake lever causes movement of the brake cable.

Other aspects of the invention will become apparent by consideration of the detailed description and accompanying drawings.

### BRIEF DESCRIPTION OF THE DRAWINGS

FIG. 1 is a side view of a bicycle embodying the present invention.

FIG. 2 is an enlarged front perspective view of a handlebar assembly from the bicycle illustrated in FIG. 1.

FIG. 3 is a right-side perspective view of a brake mechanism from the bicycle of FIG. 1.

FIG. 4 is a left-side exploded perspective view of the brake mechanism of FIG. 3.

FIG. 5 is perspective view of portions of the handlebar assembly of FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

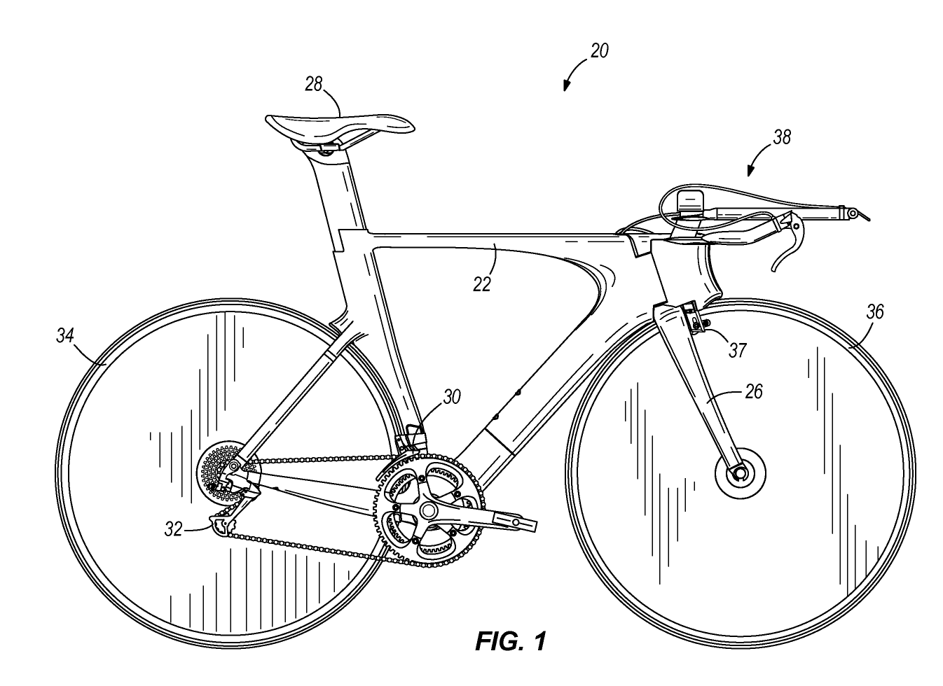

FIG. 1 illustrates a bicycle 20 including a main frame 22, a front fork 26 rotationally supported by the main frame 22, and a seat 28 supported by the main frame 22. Front and rear derailleurs 30,32 facilitate the shifting of gears on the bicycle 20. The main frame 22 and fork 26 are supported by a rear wheel 34 and a front wheel 36. A brake 37 can be used to control the speed of the bicycle 20. A handlebar assembly 38 is coupled to the front fork 26, as described in more detail below.

The illustrated handlebar assembly 38 includes a handlebar stem 40 coupled to the front fork 26, and a base bar 42 secured to the handlebar stem 40. The illustrated base bar 42 is clamped to the handlebar stem 40, but could instead be integrally formed with the handlebar stem 40. The base bar 42 (commonly called a bull horn bar) includes two wide-grip locations 44 (commonly called the “drops”) for the user to engage when riding the bicycle. The drops 44 are commonly used when the rider is accelerating quickly or climbing a hill.

Handlebar extensions 46 are secured to the base bar 42. The illustrated extensions 46 are bolted to the base bar 42, but could instead be integrally formed with the base bar 42. The extensions 46 include two narrow-grip locations 48 for the user to engage when riding. The narrow-grip locations 48 are typically engaged in order to achieve an aerodynamic riding position. In this position, the rider's forearms rest on arm supports 50, as is known in the art.

Each extension 46 includes a main shifter 52,54 that shifts one of the two derailleurs 30,32. In the illustrated embodiment, the right shifter 52 shifts the rear derailleur 30, and the left shifter 54 shifts the front derailleur 32. Each main shifter 52,54 operates substantially the same, and therefore only the right main shifter 52 will be described in detail.

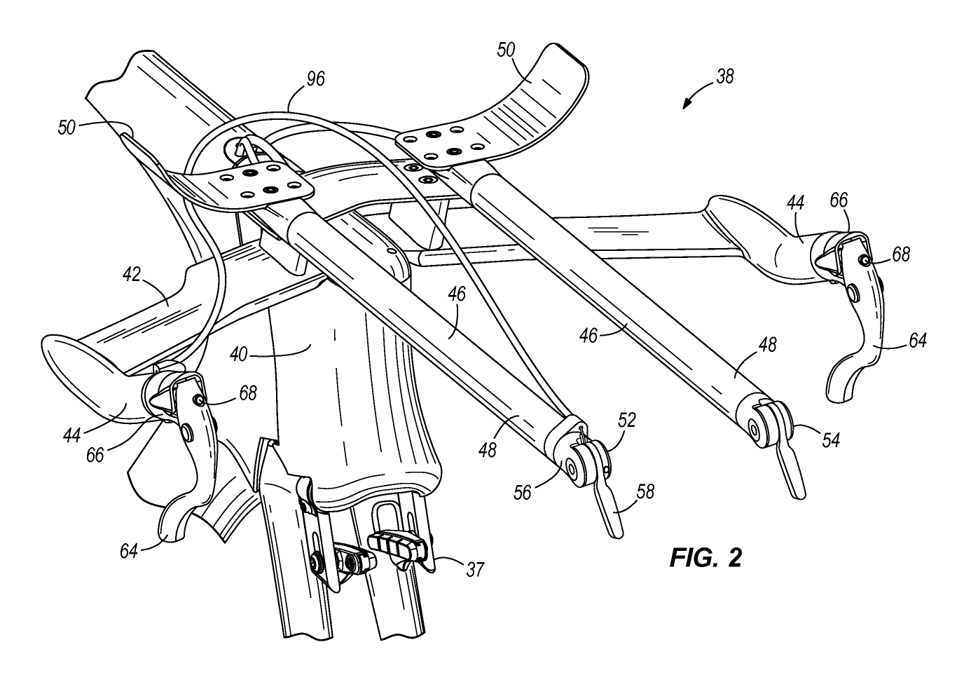

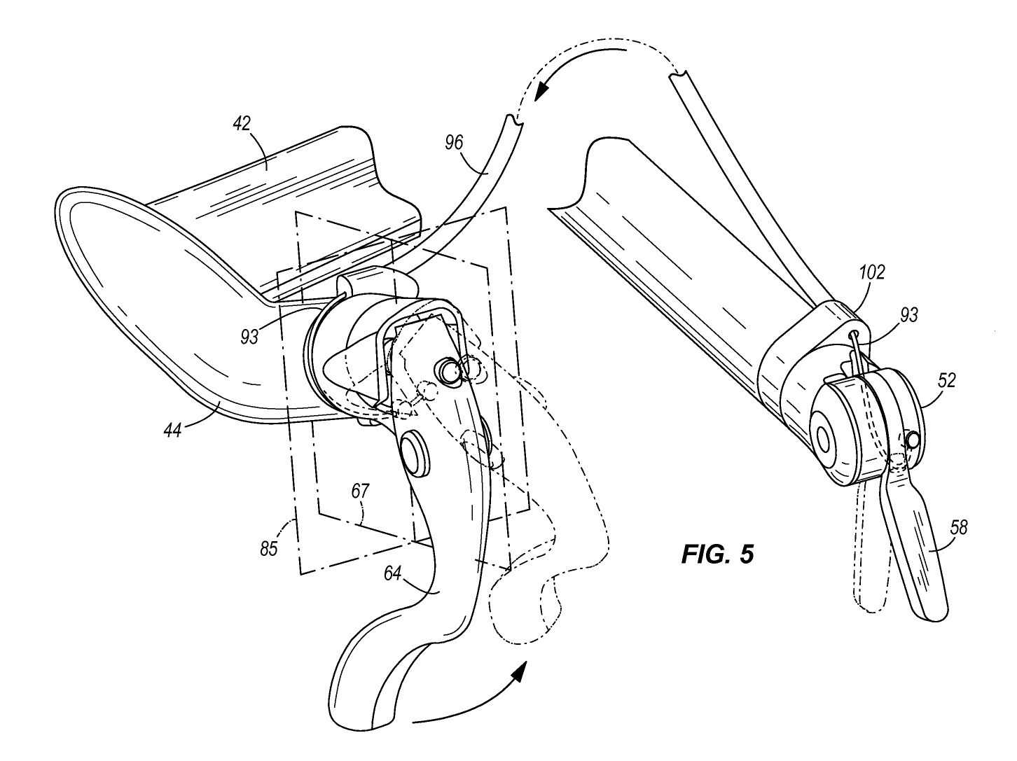

The right main shifter 52 includes a shifter base 56 positioned partially in the end of the corresponding extension 46, and a shift lever 48 pivotally attached to the shifter base 56. A main shift cable (not shown) couples the shift lever 48 to the rear derailleur, as is known in the art. The shift lever 58 is a ratchet-type lever that will return to a neutral position (shown in FIG. 2) after shifting. For example, if the illustrated right shift lever 58 is moved downward from the illustrated neutral position (broken lines in FIG. 5), the rear derailleur 32 will upshift and, when the right shift lever 58 is released, it will return to the neutral position (shown in FIG. 2 and solid lines in FIG. 5). Similarly, if the illustrated right shift lever 58 is moved upward, the rear derailleur 32 will downshift and, when the right shift lever 58 is released, it will return to the neutral position. The left shifter 54 is designed to shift the front derailleur 30 in a similar manner. This basic design for a ratcheting shift lever is known in the art and will not be described further in this document.

A brake mechanism 60,62 is secured to each end of the base bar 42. Each brake mechanism 60,62 includes a brake lever 64 pivotally mounted on a lever base 66 for rotation about a lever axis. The brake lever 64 can be engaged by a user to move a brake cable 68 to operate a bicycle brake, as is known in the art. The left brake mechanism 62 operates the front brake 37, and the right brake mechanism 60 operates a rear brake (not shown). The illustrated brake cables 68 are threaded through the base bars 42.

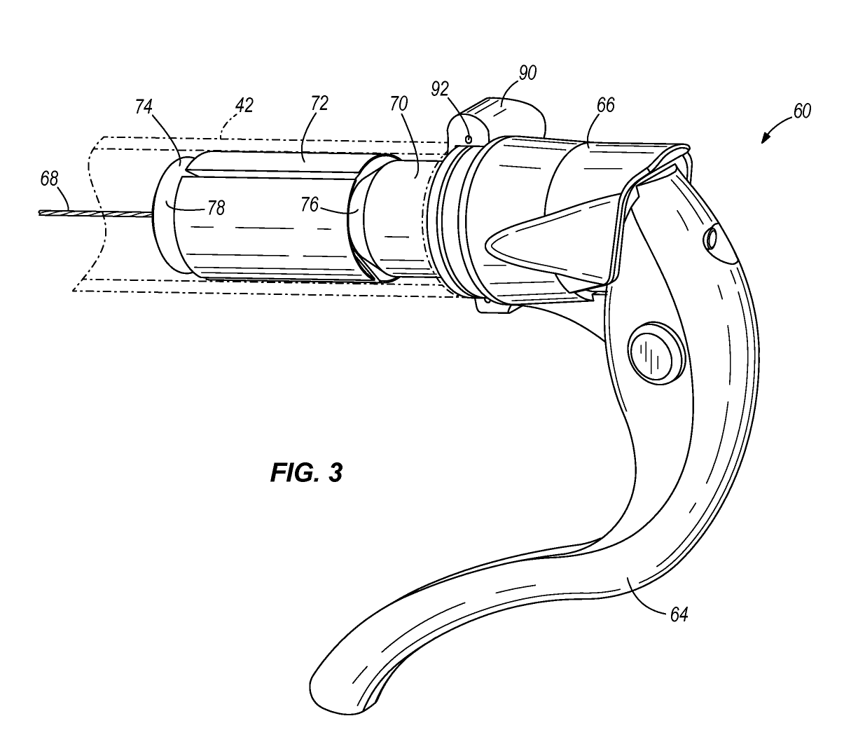

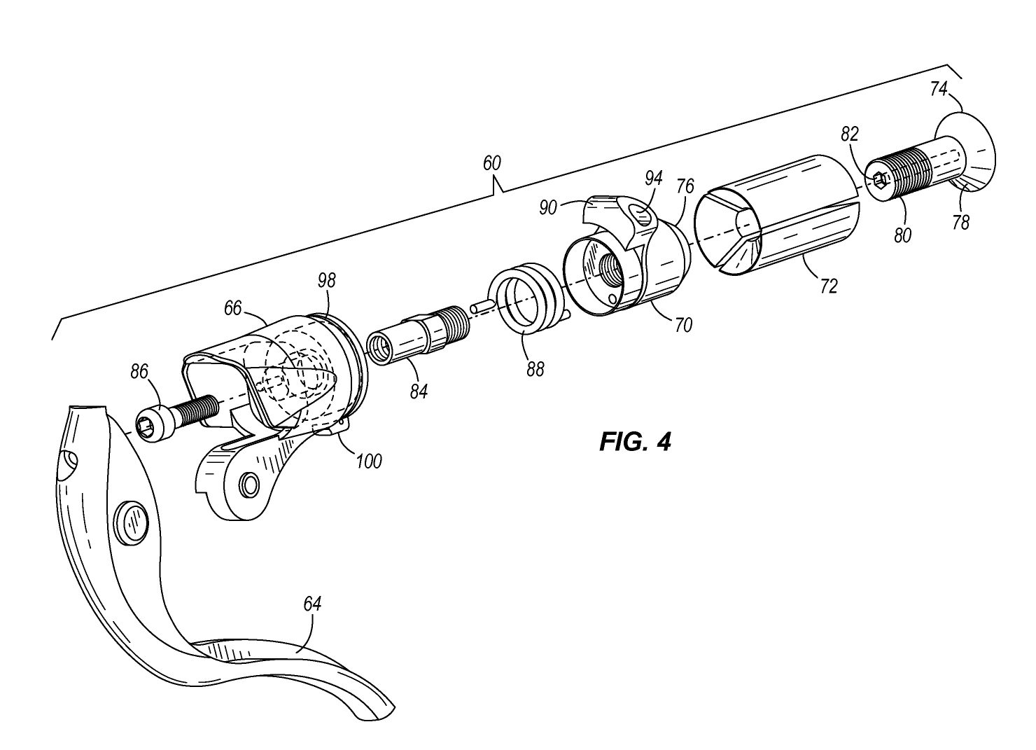

The right brake mechanism 60 is shown in more detail in FIGS. 3 and 4 and further includes a brake support 70 secured to the end of the base bar 42 by wedges 72 and an anchor screw 74. More specifically, the brake support 70 includes a frustoconical surface 76 that engages one end of the wedges 72, and the anchor screw 74 also includes a frustoconical surface 78 that engages the other end of the wedges 72. By threading the anchor screw 74 into the brake support 70, the wedges 72 are forced radially outward into engagement with the interior of the base bar 42 to thereby secure the brake support 70 to the base bar 42. A threaded end 80 (FIG. 3) of the anchor screw 74 includes a hexagonal socket 82 that is adapted to be engaged by a hex key tool (not shown) inserted through the brake support 70 to facilitate tightening the anchor bolt 74.

A brake stud 84 is threaded into the brake support 70 and provides a fixed structure for mounting the lever base 66. The lever base 66 is mounted for lateral rotation on the brake stud 84 about a base axis, and is secured in place by a mounting screw 86. The lever base 66 can be rotated inward about the base axis from a neutral position relative to the brake support 70. A torsion spring 88 is positioned between the brake support 70 and the lever base 66 to rotationally bias the lever base 66 back to the neutral position.

The brake support 70 includes a first housing stop 90 including a hole 92 (FIG. 3) for receiving an auxiliary shift cable 93 (FIG. 5), and a cylindrical recess 94 (FIG. 4) for receiving the end of an auxiliary shift housing 96 (FIG. 5). The lever base 66 includes a cable groove 98 positioned circumferentially around the lever base 66, and a cable anchor 100 for securing the end of the auxiliary shift cable 93 to the lever base 66. The auxiliary shift cable 93 is secured to the cable anchor 100 (e.g., by a clamp) and extends around the lever base 66 in the cable groove 98. The auxiliary shift cable 93 then passes through the hole 92 and into the auxiliary shift housing 96.

The other end of the auxiliary shift housing 96 is positioned in a second housing stop 102 near the right shifter 52. The second housing stop includes a hole 104 for receiving the auxiliary shift cable 93, and a cylindrical recess (not visible) for receiving the other end of an auxiliary shift housing 96. The auxiliary shift cable 93 passes through the second housing stop 102 and wraps around a lower side of the right shift lever 58. The end of the auxiliary shift cable 93 is secured to the right shift lever 58 such that upward movement of the shift lever 58 will pull the auxiliary shift cable 92.

In operation, the right shifter 52 can be used at any time to shift the rear derailleur 32 in both upshift and downshift directions by moving the right shift lever 58 downward and upward, respectively. After a shift, the shift lever 58 will return to its neutral position due to a biasing mechanism (not shown).

The brake lever 64 can be rotated inward (i.e., toward the centerline of the bicycle 20, and shown in broken lines in FIG. 5) to cause the auxiliary shift cable 93 to be pulled, which forces the main shift lever 58 to rotate downward (shown in broken lines in FIG. 5), resulting in upshifting of the rear derailleur 32. After the brake lever 64 is released, it will return to its neutral position due to the torsion spring 88, and the shift lever 58 will return to its neutral position, as described above. Accordingly, it can be seen that the illustrated brake lever 64 can act as an auxiliary shift lever to cause upshifting of the corresponding derailleur. This is particularly useful when the rider is grasping the base bar 42 (e.g., when standing on the pedals), thus eliminating the need for the rider to change hand positions in order to upshift.

The illustrated embodiment is shown with an auxiliary shift cable that facilitates upshifting of the rear derailleur using the brake lever. If desired, an additional auxiliary shift cable could be added in order to facilitate downshifting of the rear derailleur. This would be done by attaching this additional auxiliary shift cable such that outward rotation of the brake lever pulls the additional auxiliary shift cable and results in upward rotation of the corresponding main shift lever. Alternatively, a two-way actuating member (e.g., a mechanical linkage or a two-way cable actuator) could be used to achieve both upshifting and downshifting capabilities using a single actuator.

In addition, while not shown in the illustrated embodiment, it should be understood that the left brake mechanism could be designed to act as an auxiliary shift lever for actuating the left shifter. Such a design would facilitate shifting of the front derailleur using either the left shifter or the brake lever of the left brake mechanism.

Various features and advantages of the invention are set forth in the following claims.

What is claimed is:

1. A bicycle comprising:
two wheels;
a frame supported on the two wheels;
a brake;
a gear shift mechanism;
a shifter for changing a gear ratio of the gear shift mechanism; and
a brake mechanism coupled to the brake and also coupled to the gear mechanism, the brake mechanism including a brake support, a lever base pivotably mounted to the brake support for rotation about a first axis, and a brake lever pivotably mounted to the lever base for rotation about a second axis,
wherein the shifter is remote from the brake mechanism and is coupled to the brake lever such that the lever base and the brake lever rotate about the first axis in response to shifter movement.

2. A bicycle as claimed in claim 1, wherein the gear shift mechanism comprises a chain derailleur.

3. A bicycle as claimed in claim 1, wherein the shifter comprises a shift lever.

4. A bicycle as claimed in claim 1, further comprising a handlebar assembly coupled to the frame, and wherein the shifter and brake mechanism are mounted on the handlebar assembly.

5. A bicycle as claimed in claim 4, wherein the brake support is fixedly secured to the handlebar assembly.

6. A bicycle as claimed in claim 5, wherein the lever base is rotationally biased relative to the brake support.

7. A bicycle as claimed in claim 5, wherein the brake mechanism further comprises an auxiliary shift cable secured to the lever base such that rotation of the lever base causes movement of the auxiliary shift cable.

8. A bicycle as claimed in claim 5, wherein the brake mechanism further comprises a brake cable positioned through both the brake support and the lever base and secured to the brake lever such that movement of the brake lever causes movement of the brake cable.

9. A bicycle as claimed in claim 4, wherein the handlebar assembly comprises a base bar and an extension, and where the shifter is mounted on the extension and the brake mechanism is mounted on the base bar.

10. A bicycle as claimed in claim 1, wherein the brake lever is movable in at least two different planes.

11. A bicycle as claimed in claim 10, wherein movement of the brake lever in one of the at least two different planes actuates the brake, and wherein movement of the brake lever in the other of the at least two different planes actuates the gear mechanism.

12. A bicycle as claimed in claim 1, wherein the brake mechanism is coupled to the shifter.

13. A bicycle as claimed in claim 1, wherein the shifter includes a shift lever, and wherein the bicycle further includes a cable connecting the brake lever to the shift lever.
